(19) United States
(12) Patent Application Publication
(10) Pub. No.: US 2023/0043303 A1
(43) Pub. Date: Feb. 9, 2023

(54) STORAGE DEVICE

(71) Applicant: Apacer Technology Inc., New Taipei City (TW)

(72) Inventor: Jiunn-Chang Lee, New Taipei City (TW)

(21) Appl. No.: 17/576,172

(22) Filed: Jan. 14, 2022

(30) Foreign Application Priority Data
Aug. 9, 2021 (TW) 110129216

(51) Int. Cl. G06F 9/4401

(52) U.S. Cl. CPC G06F 9/4401

(57) ABSTRACT

A storage device is disclosed and includes a control unit and a storage unit. The control unit is electrically connected to a host. The storage unit is connected to the control unit and includes a first namespace and a second namespace, which are set independently of each other. The first namespace is controlled by the control unit and is configured to store data. The second namespace includes a small operating system, which is controlled by the control unit, and configured to execute a booting operation of the host and an operating function on the data in the first namespace.

### FIELD OF THE INVENTION

The present disclosure relates to a storage device, and more particularly to a storage device having a related independent bootable small operating system pre-installed therein, capable of executing operating functions of the storage device, and realizing multiple applications of the storage device.

### BACKGROUND OF THE INVENTION

With the rapid development of computer technology, storage devices have become indispensable components. In response to different operating systems or the personal requirements of the users, the storage devices are used for diversified application planning For example, a conventional non-volatile memory express (NVMe) solid-state disk (SSD) is taken as an example. In an identical physical disk space, namespace planning is utilized to execute more than one logical space, and the planned logical spaces are regarded as individual storage devices, respectively, for users to carry out more diversified applications.

On the other hand, data restoration and backup are very important for users. When data is lost or damaged, if the storage device allows the data restoration function to be provided therefrom, it facilitates the system to recover to the normal operating conditions as soon as possible. Generally speaking, there are two main triggering methods executed through the hardware or the software, respectively, for the data restoration and backup of the storage device. If the hardware is used for triggering, an additional design has to be implemented on the system, and the cost has to be increased. If an instruction of the software in the system is used for triggering, it doesn't function in case of system crash, so that the backup or restoration function fails to be achieved.

Therefore, there is a need of providing a storage device utilizing an existed namespace function to have a related independent bootable small operating system pre-installed therein, and executing operating functions of the storage device, so as to realize the multiple applications of the storage device and solve the above-mentioned drawbacks in prior arts.

### SUMMARY OF THE INVENTION

An object of the present disclosure is to provide a storage device. By designing two namespaces in the storage unit of the storage device, one namespace includes accessible sectors for normal operation, and another namespace includes a bootable small operating system, such as an extensible firmware interface (EFI) or a Windows PE (WinPE), pre-installed therein and allowed to issue an instruction to the control unit of the storage device, so as to execute the storage-device backup, the storage-device restoration, the storage-device detection, the storage-device information reading and the storage-device firmware update. When the storage device is connected to a host through the peripheral component interconnect express (PCI Express or PCIe), the control unit of the storage device is allowed to receive an instruction from the host to access data on the storage device, and receive a trigger instruction to start a small operating system pre-installed therein to realize multiple applications of the storage device. Since the small operating system is pre-installed in another namespace of the storage device, the space having the normal data-storage capacity is not influenced. Moreover, when the operating system of the host computer is crashed, the user is allowed to provide an instruction through for example but not limited to the cold reboot, so as to start the small operating system and executing the operating functions of the storage device. The user does not need to add an additional hardware or install an additional software.

Another object of the present disclosure is to provide a storage device. By utilizing the namespace function through the non-volatile memory express (NVMe) interface, two namespaces are planned, one namespace is the user space for the user to store data, and another namespace has a small operating system, such as the EFI or the WinPE, pre-installed therein and allowed to execute the booting operation independently and execute the related software functions. In that, the related independent bootable small operating system owned by the storage device is achieved. The owned system of the storage device is allowed to execute related specific functions, so that the out-of-band (OOB) module of the external device of or an additional hardware design is reduced, and there is no need to prepare an external flash drive as a boot system to execute the related functions. The control unit of the storage device is capable of recognizing the received instruction and automatically selecting an access operation of the data stored in the first namespace, or a trigger operation of the small operating system pre-installed in the second namespace, so as to execute the booting operation of the host and execute the operating function of the storage device. The user does not need to add additional burdens of the hardware or the software. That is, there is no need to install any software, and no need to add any hardware. Through the interface provided by the small operating system pre-installed in the second namespace, it allows to execute the special applications or execute the firmware settings. Preferably but not exclusively, each file stored in the second namespace is a read-only file and write-protected, and it ensures that the second namespace can safely and stably exert the execution of the small operating system. If the control unit does not receive the trigger instruction for executing the small operating system pre-installed in the second namespace, the user's access to the first namespace through the control unit is not influenced by the small operating system pre-installed in the second namespace, and the access operation of the data in the storage device is not affected.

In accordance with an aspect of the present disclosure, a storage device is provided and includes a control unit and a storage unit. The control unit is electrically connected to a host. The storage unit is connected to the control unit and includes a first namespace and a second namespace set independently relative to each other. The first namespace is controlled by the control unit and configured to store data. The second namespace includes a small operating system controlled by the control unit, and configured to execute a booting operation of the host and an operating function on the data stored in the first namespace.

In an embodiment, the small operating system includes an extensible firmware interface or a Windows PE.

In an embodiment, the storage device and the host are connected through a communication transmission, and the communication transmission meets a standard of peripheral component interconnect express.

In an embodiment, the operating function is one selected from the group consisting of a storage-device backup function, a storage-device restoration function, a storage-device detection function, a storage-device enable-write-protection function, a storage-device disable-write-protection function and a storage-device firmware-update function.

In an embodiment, the first namespace includes a data-accessible partition and a data-hidden partition, the data is stored in the data-accessible partition for the control unit to access, and the data-hidden partition is used to back up the data stored in the data-accessible partition.

In an embodiment, the data-accessible partition has a partition size equal to that of the data-hidden partition.

In an embodiment, each file in the second namespace is a read-only file.

In an embodiment, when the control unit receives a trigger instruction transmitted from the host, the small operating system is executed, wherein the trigger instruction is one selected form the group consisting of a general purpose input/out signal, a cold boot signal, an application-trigger signal, and a hot-plug signal.

In an embodiment, the first namespace is a user space, and the second namespace is a reserved space.

In an embodiment, the storage device is a solid-state disk with a non-volatile memory express (NVMe) interface.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a functional block illustrating a storage device connected with a host according to a first embodiment of the present disclosure; and

FIG. 2 is a functional block illustrating a storage device connected with a host according to a second embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

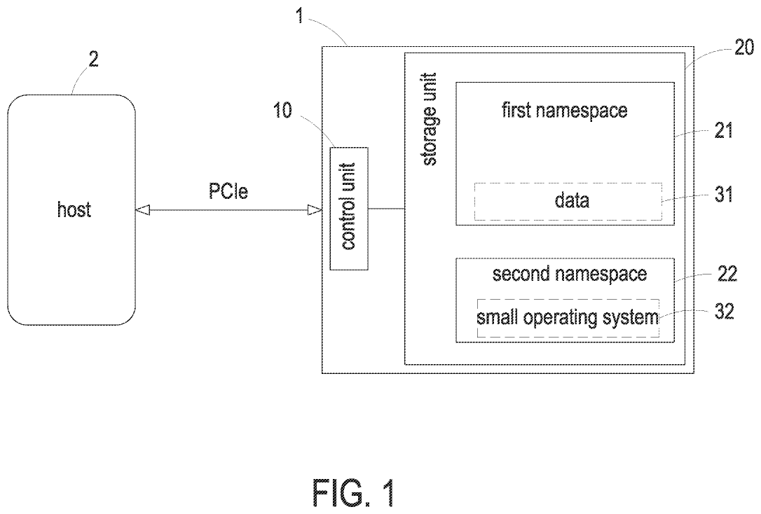

FIG. 1 is a functional block illustrating a storage device connected with a host according to a first embodiment of the present disclosure. In the embodiment, the storage device 1 includes a control unit 10 and a storage unit 20. The control unit 10 is electrically connected to a host 2. The storage unit 20 is connected to the control unit 10 and includes a first namespace 21 and a second namespace set 22. Preferably but not exclusively, the first namespace 21 is a user space, and the second namespace 22 is a reserved space. The first namespace 21 and the second namespace 22 are set independently relative to each other. In the embodiment, the first namespace 21 is controlled by the control unit 10 and configured to store data 31. In the embodiment, the second namespace 22 includes a small operating system 32 controlled by the control unit 10. The small operating system 32 is configured to execute a booting operation of the host 2 and an operating function on the data 31 stored in the first namespace 21.

In the embodiment, the storage device 1 and the host 2 are connected through a communication transmission, and the communication transmission meets a standard of peripheral component interconnect express (PCI Express or PCIe for short). The control unit 10 is allowed to receive an operating instruction to access the first namespace 21 of the storage unit 20, and allowed to receive a trigger instruction transmitted from the host 2 to start the small operating system 32 pre-installed in the second namespace 32, so as to execute a booting operation of the host 2 and an operating function on the data 31 stored in the first namespace 21.

Notably, in the embodiment, the storage unit 20 of the storage device 1 is divided into the first namespace 21 for accessing the data 31 and the second namespace 22 for pre-installing the small operating system 32. The first namespace 21 and the second namespace 22 are controlled through the control unit 10. In an embodiment, under a normal situation, when an operating instruction is transmitted from the host 2 to the control unit 10 of the storage device 1, the control unit 10 only accesses the data 31 stored in the first namespace 21. On the other hand, since the small operating system 32 is pre-installed in the second namespace 22 of the storage device 1, it allows the user to start the execution of the small operating system 32 by providing a trigger instruction. Preferably but not exclusively, the trigger instruction is a cold boot signal. In that, the small operating system 32 is started to execute operating functions or special settings. In another embodiment, the second namespace 22 is selected to use through the basic input/out system (BIOS) of the host 2. In this way, through a mechanism of triggering activation, it allows the small operating system 32 pre-installed in the namespace 22 to execute the operating functions or the special settings. There is no need to increase the cost of the hardware. Moreover, the time and the labor for developing the special application software/firmware are reduced.

Preferably but not exclusively, in the embodiment, the storage device 1 is a solid-state disk (SSD) with a non-volatile memory express (NVMe) interface. Preferably but not exclusively, the first namespace 21 of the storage unit 20 includes a user space with a capacity of 1 TB for the user to access the data 31. Preferably but not exclusively, the second namespace 22 includes a reserved space with a capacity of 100 MB for pre-installing the small operating system 32, such as a Windows PE (WinPE) or an extensible firmware interface (EFI). In other embodiments, the capacities and the ratio configuration of the first namespace 21 and the second namespace 22 are adjustable according to the practical requirements, and the present disclosure is not limited thereto.

Moreover, in the embodiment, when the control unit 10 of the storage device 1 receives the trigger instruction transmitted from the host 2, the small operating system 32 pre-installed in the second namespace 22 is executed. Preferably but not exclusively, the trigger instruction is one selected form the group consisting of a general purpose input/out (GPIO) signal, a cold boot signal, an application-trigger signal, and a hot-plug signal. In another embodiment, the trigger instruction includes a trigger signal generated by executing a software application of the host 2. In the embodiment, when the user performs a cold boot procedure of the system in the host 2 for using the storage device 1, a cold boot signal is generated. The cold boot signal is trigged to generate by executing the cold boot procedure of the system in the host 2. Then, the control unit 10 of the storage unit 1 is allowed to receive the cold boot signal from the system of the host 2. After that, the control unit 10 loads the small operating system 32 and reports the second namespace 22 to the host 2 for the system of the host 2 to use. Preferably but not exclusively, the small operating system 32 includes an extensible firmware interface (EFI) or a Windows PE. Through the tools or the interface provided by the small operating system 32, it allows the user to execute and issue the supporting instruction to the control unit 10 through the host 2, so that the control unit 10 is triggered to execute an operating function on the data 31 stored in the first namespace 21. In an embodiment, the extensible firmware interface (EFI) is taken as an example, and the command-line interface (CLI) of EFI shell is utilized for implementation to achieve the purpose of communication between the user and the control unit 10. Certainly, the commands and the operation methods of the EFI Shell are already well known to those with ordinary knowledge in the related fields, and not redundantly described herein.

In the embodiment, the operating function for the control unit 10 to execute is one selected from the group consisting of a storage-device backup function, a storage-device restoration function, a storage-device detection function, a storage-device enable-write-protection function, a storage-device disable-write-protection function and a storage-device firmware-update function. In an embodiment, the user performs the operating function through the command line provided by the EFI shell in the second namespace 22, so that the control unit 10 is allowed to execute different operating functions on the first namespace 21 in the storage unit 20. When the operating function is completed, it allows to exit the small operating system 32, so that the warm boot procedure for the system of the host 2 is started. After the warm boot procedure is completed, the storage device 1 reports 1 TB of the first namespace 21 to the host 2 for the user to access the data 31. Preferably but not exclusively, in the embodiment, each file including the related files of the small operating system 32 in the second namespace 22 is a read-only file. Moreover, the second namespace 22 is write-protection for the user of the host 2. It ensures that the second namespace 22 can safely and stably exert the execution of the small operating system 32.

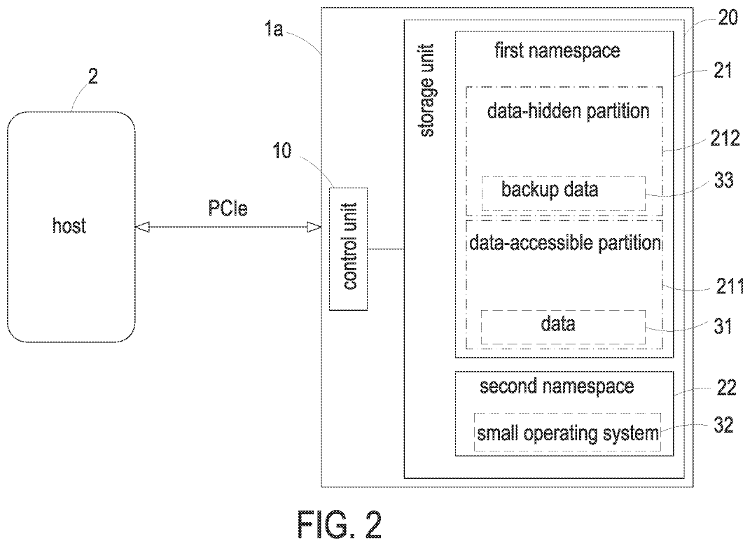

FIG. 2 is a functional block illustrating a storage device connected with a host according to a second embodiment of the present disclosure. In the embodiment, the structures, elements and functions of the storage device la are similar to those of the storage device 1 of FIG. 1, and are not redundantly described herein. In the embodiment, the storage device la is a non-volatile memory express (NVMe) solid-state disk (SSD). Preferably but not exclusively, the first namespace 21 of the storage unit 20 includes a user space with a capacity of 1 TB for the user to access the data 31. Preferably but not exclusively, the second namespace 22 includes a reserved space with a capacity of 100 MB for pre-installing the small operating system 32, such as an extensible firmware interface (EFI) or a Windows PE (WinPE). In the embodiment, the small operating system 32 is pre-installed in the second namespace 22 of the storage device 1a before leaving the factory. Under the small operating system 32 familiar to the original manufacturer, it allows to select the developed software applications to install in the second namespace 22. The type of the small operating system 32 is not limited in the present disclosure. Any small operating system capable of executing the booting operation of the host 2 and the operating function on the data stored in the first name space 21 is applicable to the present disclosure. Preferably but not exclusively, each file in the second namespace 22 is a read-only file, and it ensures that the second namespace 22 can safely and stably exert the execution of the small operating system 32.

In the embodiment, the storage device la and the host 2 are connected through the communication transmission meeting the standard of PCIe. The control unit 10 of the storage device 1a connected to the storage unit 20 is allowed to receive an operating instruction to access the first namespace 21 of the storage unit 20, and allowed to receive a trigger instruction transmitted from the host 2 to start the small operating system 32 pre-installed in the second namespace 32, so as to execute a booting operation of the host 2 and an operating function on the data 31 stored in the first namespace 21.

In the embodiment, the small operating system 32 is pre-installed in the second namespace 22 of the storage device 1a. Preferably but not exclusively, the user is allowed to provide the trigger instruction to the small operating system 32 through the cold boot procedure of the host 2, so as to execute the booting operating of the host 2 and the operating function on the data 31 stored in the first namespace 21. Preferably but not exclusively, the operating function is one selected from the group consisting of a storage-device backup function, a storage-device restoration function, a storage-device detection function, a storage-device enable-write-protection function, a storage-device disable-write-protection function and a storage-device firmware-update function. The user does not need to add an additional hardware or install an additional software on the host 2 or the storage device 1a. Preferably but not exclusively, the trigger instruction provided to the small operating system 32 is a general purpose input/out (GPIO) signal. The system of the host 2 is started through the cold boot procedure of the host 2 by the user for connecting the storage device la.

In an embodiment, the system of the host 2 is configured to wait for a specific period of time, for example, 5 seconds. If the user enters the warm boot procedure without any action, the operating system in the host 2 is executed to complete the booting operation. After the booting operation is completed, the communication transmission between the host 2 and the storage device 1a is achieved through the standard of PCIe, and the operation instruction is transmitted to the control unit 10 of the storage device 1a.

In another embodiment, if any keyboard button or a specific keyboard button connected to the host 2 is touched by the user within a specific time, a general purpose input/out (GPIO) signal is generated. It allows the control unit 10 of the storage device la to receive the general purpose input/out (GPIO) signal, served as the trigger instruction for the small operating system 32, from the system of the host 2. Then, the control unit 10 loads the small operating system 32 to execute the booting operation of the host 2, and reports the second namespace 22 to the host 2 for the user to use. Through the EFI Shell interface or a plurality of software applications in the second namespace 22, the user is allowed to control the control unit 10 of the storage device la to execute a special operating function. Preferably but not exclusively, a storage-device backup function, a storage-device restoration function, a storage-device detection function, a storage-device enable-write-protection function, a storage-device disable-write-protection function or a storage-device firmware-update function is executed on the first namespace 21. After the user completes the application of the operating function, it allows to exit the small operating system 32, so that the warm boot procedure for the system of the host 2 is started. After the warm boot procedure is completed, the storage device 1a reports 1 TB of the first namespace 21 to the host 2 for the user to access the data 31. Preferably but not exclusively, in the embodiment, the second namespace 22 and the small operating system 32 are write-protection, and each file in the second namespace 22 is a read-only file, so that the user's access to the first namespace 21 of the storage unit 20 through the control unit 10 is not influenced. In other words, when the small operating system 32 is not triggered to start, the access operation of the data 31 in the storage device la is not affected.

From the above descriptions, in addition to the first namespace 21 provided for accessing the data 31, the second namespace 22 independent from the first namespace 21 is further provided. It allows the original manufacturer of the storage device 1a to use the second namespace 22 to pre-install the small operating system 32 and the software applications for the related applications in the simplest way. When the storage device la needs to add an additional function of the firmware to access the data 31 in the first namespace 21, the small operating system 32 in the second namespace 22 is triggered through the trigger instruction to achieve the purpose. In that, the modification of the firmware is very low, and the labor and the time for developing the software application. On the other hand, for the user of the storage device 1a, there is no need to modify any hardware or install any additional software during use. Even if the user's operating system is damaged and fails to be activated, the small operating system 32 of the storage device 1a is allowed to execute the special operations. It is helpful of increasing the user acceptance greatly. Moreover, each file, including the small operating system 32, stored in the second namespace is a read-only file. It ensures that the second namespace 22 can safely and stably exert the execution of the small operating system 32. If the small operating system 32 is not triggered to start, the user's access to the first namespace 21 through the control unit 10 is not influenced by the second namespace 22, and the access operation of the data 31 in the storage device 1a is not affected.

In the embodiment, the first namespace 21 includes a data-accessible partition 211 and a data-hidden partition 212. Preferably but not exclusively, the data 31 is stored in the data-accessible partition 211 for the control unit 10 to access, and the data-hidden partition 212 is used to back up the data 31 stored in the data-accessible partition 211 to form backup data 33. In the embodiment, the data-accessible partition 211 has a partition size equal to that of the data-hidden partition 212. In an embodiment, when the small operating system 32 pre-installed in the second namespace 22 is triggered through the trigger instruction from the host 2 by the user, the control unit 10 of the storage device la executes the booting operation of the host through the small operating system 32 of the second namespace 22, and executes the backup function of the storage device la. In that, the control unit 10 backs up the data 31 stored in the data-accessible partition 211 in the first namespace 21 to the data-hidden partition 212 to form the backup data 33 stored in the data-hidden partition 212. In another embodiment, when the small operating system 32 pre-installed in the second namespace 22 is triggered through the trigger instruction from the host 2 by the user, the control unit 10 of the storage device la executes the booting operation of the host through the small operating system 32 of the second namespace 22, and executes the restoration function of the storage device 1a. Through the control unit 10, the data-accessible partition 211 with the data 31 is restored according to the backup data stored in the data-hidden partition 212, or restored to an initial state of the data-accessible partition 211. Preferably but not exclusively, in the embodiment, the first namespace 21 is a user space with a capacity of 1 TB. The data-accessible partition 211 has the partition size equal to that of the data-hidden partition 212. Preferably but not exclusively, the data-accessible partition 211 and the data-hidden partition 212 have the partition size of 500 MB, respectively. When the small operating system 32 in the second namespace 22 is not triggered to start and the operating instruction is transmitted to the control unit 10 of the storage device la by the host 2, the control unit 10 reports the data-accessible partition 211 of the first namespace 21 for the user to access the data 31. At this time, the backup data 33 of the data-hidden partition 212 is hidden, so that the data-accessible partition 211 of the first namespace 21 in the storage unit 20 accessed by the user from the host 2 through the control unit 10 is not influenced. In other words, the user's access to the data 31 of the storage device la is not influenced by the existence of the second namespace 22, the small operating system 32 and the data-hidden partition 212. Certainly, the present disclosure is not limited thereto and not redundantly described herein.

In summary, the present disclosure provides a storage device. By designing two namespaces in the storage unit of the storage device, one namespace includes accessible sectors for normal operation, and another namespace includes a bootable small operating system, such as the extensible firmware interface (EFI) or Windows PE (WinPE), pre-installed therein and allowed to issue an instruction to the control unit of the storage device, so as to execute the backup, the restoration, the detection, the storage-device information reading and the firmware update. When the storage device is connected to a host through the peripheral component interconnect express (PCI Express or PCIe), the control unit of the storage device is allowed to receive an instruction from the host to access data on the storage device, and receive a trigger instruction to start a small operating system pre-installed therein to realize multiple applications of the storage device. Since the small operating system is pre-installed in another namespace of the storage device, the space having the normal data-storage capacity is not influenced. Moreover, when the operating system of the host computer is crashed, the user is allowed to provide an instruction through for example but not limited to the cold reboot, so as to start the small operating system and executing the operating functions of the storage device. The user does not need to add an additional hardware or install an additional software. By utilizing the namespace function through the non-volatile memory express (NVMe) interface, two namespaces are planned, one namespace is the user space for the user to store data, and another namespace has a small operating system, such as EFI or WinPE, pre-installed therein and allowed to execute the booting operation independently and the related software functions. In that, the related independent bootable small operating system owned by the storage device is achieved. The owned system of the storage device is allowed to execute related specific functions, so that the out-of-band (OOB) module of the external device of or an additional hardware design is reduced, and there is no need to prepare an external flash drive as a boot system to execute the related functions. The control unit of the storage device is capable of recognizing the received instruction and automatically selecting an access operation of the data stored in the first namespace, or a trigger operation of the small operating system pre-installed in the second namespace, so as to execute the booting operation of the host and the operating function of the storage device. The user does not need to add additional burdens of the hardware or the software. That is, there is no need to install any software, and no need to add any hardware. Through the interface provided by the small operating system pre-installed in the second namespace, it allows to execute the special applications or execute the firmware settings. Preferably but not exclusively, each file stored in the second namespace is a read-only file and write-protected, and it ensures that the second namespace can safely and stably exert the execution of the small operating system. If the control unit does not receive the trigger instruction for executing the small operating system pre-installed in the second namespace, the user's access to the first namespace through the control unit is not influenced by the small operating system pre-installed in the second namespace, and the access operation of the data in the storage device is not affected.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A storage device comprising:
a control unit electrically connected to a host; and
a storage unit connected to the control unit and comprising a first namespace and a second namespace set independently relative to each other, wherein the first namespace is controlled by the control unit and configured to store data, wherein the second namespace comprises a small operating system controlled by the control unit, and configured to execute a booting operation of the host and an operating function on the data stored in the first namespace.

2. The storage device according to claim 1, wherein the small operating system comprises an extensible firmware interface or a Windows PE.

3. The storage device according to claim 1, wherein the storage device and the host are connected through a communication transmission, and the communication transmission meets a standard of peripheral component interconnect express.

4. The storage device according to claim 1, wherein the operating function is one selected from the group consisting of a storage-device backup function, a storage-device restoration function, a storage-device detection function, a storage-device enable-write-protection function, a storage-device disable-write-protection function and a storage-device firmware-update function.

5. The storage device according to claim 1, wherein the first namespace comprises a data-accessible partition and a data-hidden partition, the data is stored in the data-accessible partition for the control unit to access, and the data-hidden partition is used to back up the data stored in the data-accessible partition.

6. The storage device according to claim 5, wherein the data-accessible partition has a partition size equal to that of the data-hidden partition.

7. The storage device according to claim 1, wherein each file in the second namespace is a read-only file.

8. The storage device according to claim 1, wherein when the control unit receives a trigger instruction transmitted from the host, the small operating system is executed, wherein the trigger instruction is one selected form the group consisting of a general purpose input/out signal, a cold boot signal, an application-trigger signal and a hot-plug signal.

9. The storage device according to claim 1, wherein the first namespace is a user space, and the second namespace is a reserved space.

10. The storage device according to claim 1, wherein the storage device is a solid-state disk with a non-volatile memory express interface.
